(19) United States
(12) Patent Application Publication
(10) Pub. No.: US 2011/0019503 A1
(43) Pub. Date: Jan. 27, 2011

(54) Apparatus For Providing A Digital Wall Calendar

(75) Inventor: Dale Oehler, Fair Haven, NJ (US)

Correspondence Address: RAYMOND R. MOSER JR., ESQ.;MOSER IP LAW GROUP, 1030 BROAD STREET, SUITE 203, SHREWSBURY, NJ, 07702, US

(73) Assignee: Dale Oehler, Fair Haven, NJ (US)

(21) Appl. No.: 12/842,709

(22) Filed: Jul. 23, 2010

Related U.S. Application Data
(60) Provisional application No. 61/228,028, filed on Jul. 23, 2009.

(51) Int. Cl. G04G 9/00; G04B 47/00; G06Q 30/00

(52) U.S. Cl. 368/10; 368/29; 705/14.49

(57) ABSTRACT

An apparatus for providing a digital wall calendar. The apparatus comprises an upper display module, a lower display module; and a logic and communication module. The upper display module displays an image. The lower display module displays a series of dates. The logic and communication module provides the image and the series of dates to the upper display module and the lower display module.

### CROSS-REFERENCE TO RELATED APPLICATIONS

This application claims benefit of U.S. provisional patent application Ser. No. 61/228,028, filed Jul. 23, 2009, which is herein incorporated in its entirety by reference.

### BACKGROUND OF THE INVENTION

1. Field of the Invention

Embodiments of the present invention generally relate to an apparatus for digital display and, more particularly, to a digital wall calendar.

2. Description of the Related Art

Wall calendars are an inexpensive tool for organizing a schedule and decorating a room. These calendars offer convenient reminders of holidays and other important events. They are commonly produced in a size and format that allows the owner to add their own personal dates and events for easy scheduling. Wall calendars placed in common areas are used to provide information to a group at a time. For example, employee schedules may be posted in a break room, or family after-school activities may be posted on a calendar in a kitchen. They also provide a platform for display of art, pictures' family photos or other visual subjects favored by the purchaser.

However, schedules constantly change, and the calendars must be updated to retain their value as organizational tools. After-school activities are cancelled or rescheduled; trash pickup days change; even national events such as the beginning of daylight savings time are in flux. Maintaining a calendar with all of these changes is a near impossible task. Dates written in pen must be crossed out, events written in pencil, erased. Every year, a new calendar must be purchased and important dates from the previous year copied over. More time may be spent updating the calendar than is saved by using it as an organizational tool.

In response to many of these issues, the use of scheduling software has become more common. Portable devices and mobile phones provide easy access to a personal schedule and date book. However, these individual scheduling tools do not provide the community access or decorative features of a wall calendar. Furthermore, many users may be accustomed to the format of the wall calendar and reluctant to begin using their phone for scheduling.

Therefore, there is a need in the art for apparatus to provide an updatable digital wall calendar.

### SUMMARY OF THE INVENTION

An embodiment of the present invention comprises an apparatus for providing a digital wall calendar. The apparatus comprises an upper display module, a lower display module; and a logic and communication module. The upper display module displays an image. The lower display module displays a series of dates. The logic and communication module provides the image and the series of dates to the upper display module and the lower display module.

In another embodiment, the apparatus comprises an upper display module, a lower display module, and a logic and communication module. The upper display module displays an image and accepts user input to perform device configuration operations. The lower display module displays a series of dates and accepts user input to select a date or modify a scheduled event. The logic and communication module communicates with a remote computer to synchronize scheduling information. The logic and communication module also selects an image from a photo album, where the image is associated with a particular date displayed on the lower display module. The logic and communication module is also configured to accept data from one or more streams, wherein the streams comprise scheduling information and one or more advertisements. The logic and communication module is further configured to populate the lower display with the scheduling information received from the one or more streams.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an embodiment of the digital wall calendar apparatus; and

FIG. 2 is a block diagram of a logic and communication module in accordance with an embodiment of the present invention.

### DETAILED DESCRIPTION

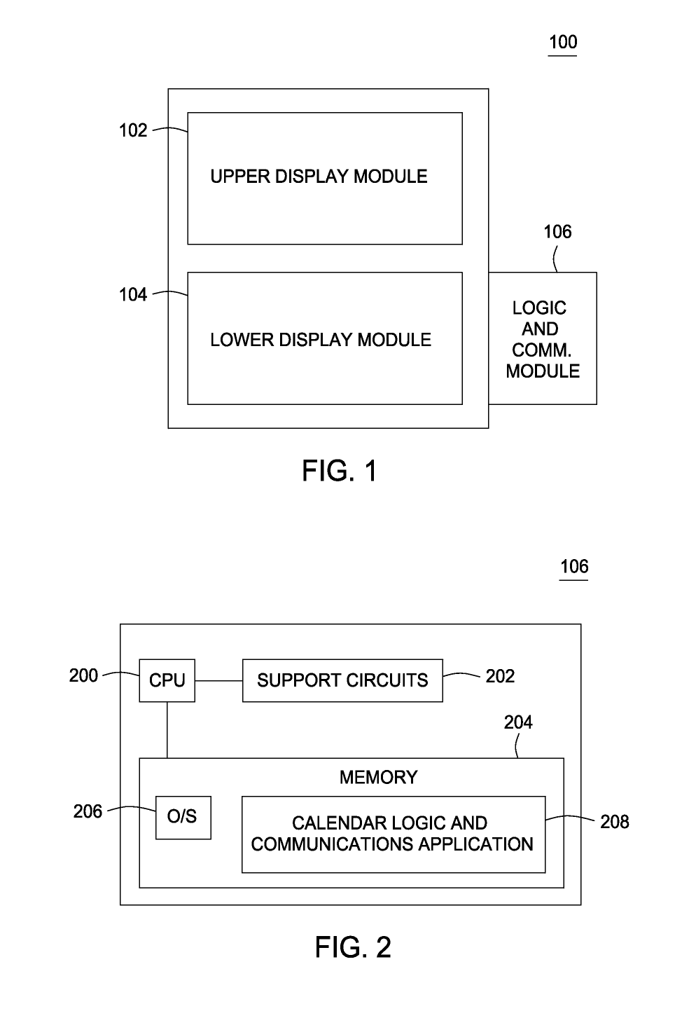

FIG. 1 is a block diagram depicting an embodiment of an apparatus for implementing a digital wall calendar. The apparatus 100 is comprised of an upper display module 102, a lower display module 104, and a logic and communications module 106. While in the present embodiment the apparatus is designed to be mounted directly on a vertical surface, such as a wall or refrigerator, one of ordinary skill in the art would recognize that such a device could be modified with a stand for mounting on a horizontal surface such as a desk or countertop.

The upper display module 102 is a video display such as generally known in the art, such as a liquid crystal display (LCD), cathode ray tube (CRT), plasma display, projection display, electronic paper, and the like. In some embodiments, the upper display module 102 displays an image, mimicking a design as seen in a traditional paper wall calendar. In some embodiments, the upper display module 102 is configurable. Possible configuration options include uploaded images, such as family pictures, public domain artwork, theme pictures (cats, dogs, flowers, beaches, etc. as seen in common paper wall calendars), or a particular data stream.

In some embodiments, the upper display module 102 may include interface functions, such as a touch screen, light pen, or mouse cursor. The upper display module 102 may display a configuration menu and allow input for modifying the behavior of the apparatus. Modifications to the displayed image or schedule may be possible through the use of this interface.

The apparatus 100 also includes a lower display module 104. The lower display module 104 is also a video display such as generally known in the art, such as a liquid crystal display (LCD), cathode ray tube (CRT), plasma display, projection display, electronic paper, and the like. In some embodiments, the lower display module 104 displays a particular time period. The particular time period may include the current day, week, month, or year. The time period corresponds to information received from the logic and communications module 106. The time period may include scheduled events input by a user, or received from a data stream.

The lower display module 104 may also include an interface, such as a touch screen, light pen, or mouse cursor. The interface may allow selection of a particular day, week, or month. Selecting a time period may expand that time period on the lower display to fill the display. The image displayed on the upper display module 102 may be altered in response to the selection of a day or event on the lower display module 104. The lower display module 104 may also provide options for scrolling through different time periods, similar to the functionality of turning a page on a paper wall calendar. In one embodiment, the lower display module 104 may allow input of schedule events via the interface.

FIG. 2 is a block diagram of an embodiment of a logic and communications module 106. In one embodiment of the present invention, the logic and communications module 106 is a general purpose computer that operates as a specific purpose computer executing a calendar logic and communications application 208. The logic and communications module may behave as a computing device such as those generally known in the art.

The logic and communications module 106 is comprised of a CPU 200, support circuits 202, and a memory 204. The CPU 200 may comprise one or more commercially available microprocessors or microcontrollers that facilitate data processing and storage. The various support circuits 202 are utilized to facilitate the operation of the CPU 200 and include such circuits as clock circuits, power supplies, cache, input/output circuits and devices, and the like. The memory 204 may comprise random access memory, read only memory, removable storage, optical disk storage, disk drive storage, and combinations thereof. The memory 204 stores an operating system 206, and a calendar logic and communications application 208. In operation, the CPU 108 executes the operating system 114 to control the general utilization and functionality of the logic and communications module 106.

The memory 204 is also comprised of a calendar logic and communications application (CLCA) 208. When executed by the CPU 200, the CLCA 208 causes the general purpose computer to behave as a specific purpose computer for the purpose of displaying a digital wall calendar. While the present embodiment describes the calendar logic and communications application 208 as implemented in software, one of ordinary skill in the art would recognize that the software module could be implemented as an application specific integrated circuit (ASIC) or a field programmable gate array (FPGA).

In some embodiments, the logic and communications module 106 is coupled to a network. In some embodiments, the logic and communications module 106 may have built in wireless connectivity, via a wireless protocol such as BLUETOOTH, ZigBee, the 802.11x protocols, and the like. In another embodiment the logic and communications module 106 may communicate with a remote network over a wired protocol, such as Ethernet. In some embodiments, the apparatus 100 may communicate with a local municipal wireless network.

In one embodiment, the CLCA 208 communicates with a remote computer running scheduling software. The scheduling software connects to the CLCA 208 for the purpose of uploading and synchronizing schedule events to the logic and communications module 106 for display on the calendar. A user may execute a command on the scheduling software to upload new schedule events to the calendar.

The CLCA 208 may receive data via the network interface for display on the calendar. In some embodiments, the CLCA 208 may receive direct instructions from a remote source as to the images and data to be displayed on the display modules. In other embodiments, the CLCA 208 receives specific schedule events, and the CLCA 208 integrates these schedule events into a displayed time period. In some embodiments, the CLCA 208 receives configuration data via the network connection. In other embodiments, the configuration is performed via the upper and lower display module interfaces. For example, the user may perform a drag and drop operation on a particular event to reschedule the event to a different time or day. In some embodiments, the CLCA 208 synchronizes schedule updates made using the wall calendar with the remote computer. In some embodiments, the configuration data includes subscriptions to network streams.

In one embodiment, the CLCA 208 may receive data from one or more network streams. These network streams comprise data received from a remote source. The remote source may be a node on a local network, or it may be a node located on the Internet. The network streams may comprise advertisements, community info and events (such as trash and recycling pickup, local concerts, school closings, and the like), artwork for display, hosted family photos, and the like. Particular advertisements may be associated with particular streams. For example, local community streams such as school or trash schedules may be associated with local advertising, or professional sports schedule streams may be associated with national ad campaigns. The CLCA 208 receives instructions from these streams to display the appropriate images and/or add events to the displayed time period. In some embodiments, the CLCA 208 may parse specific types of data from specific types of streams (e.g. automatically displaying images on the upper display module when receiving an image stream). In other embodiments, the CLCA 208 may receive executable instructions from the network streams (e.g. a flash based application to display on the upper display module).

While the foregoing is directed to embodiments of the present invention, other and further embodiments of the invention may be devised without departing from the basic scope thereof, and the scope thereof is determined by the claims that follow.

1. An apparatus for implementing a digital wall calendar comprising:
an upper display module for displaying an image;
a lower display module for displaying a series of dates; and
a logic and communication module for providing the image and the series of dates to the upper display module and the lower display module.

2. The apparatus of claim 1, wherein the logic and communication module is configured to receive schedule information from a remote computer.

3. The apparatus of claim 1, wherein the logic and communication module is configured to receive a stream of information from a source external to a local network.

4. The apparatus of claim 3, wherein the stream is associated with one or more advertisements.

5. The apparatus of claim 4, wherein the one or more advertisements are targeted based on the content of the stream.

6. The apparatus of claim 3, wherein the stream comprises a set of scheduling information.

7. The apparatus of claim 6, wherein the logic and communication module populates the series of dates with the scheduling information from the stream.

8. The apparatus of claim 1, wherein the lower display is configured to allow user input for selecting a date or range of dates to display schedule information about the particular date.

9. The apparatus of claim 1, wherein the lower display is configured to allow a user to modify events scheduled on a particular date.

10. The apparatus of claim 9, wherein the logic and communication module transmits an event modified on the lower display to a remote computer to synchronize with a scheduling program.

11. The apparatus of claim 1, wherein the logic and communication module is configured to select the image from a photo album, a public domain artwork, or a particular stream.

12. The apparatus of claim 1, wherein the logic and communication module is configured to communicate wirelessly on a network.

13. The apparatus of claim 1, wherein the upper display is implemented using E-paper technology.

14. The apparatus of claim 1, wherein the lower display is implemented using E-paper technology.

15. The apparatus of claim 1, wherein the logic and communication module selects an image from a photo album according to a displayed date on the lower display, wherein the image is associated with the displayed date.

16. The apparatus of claim 1, wherein the upper display is configured to accept user input to perform device configuration operations.

17. The apparatus of claim 16, wherein the configuration operations comprise selecting an image for the upper display.

18. The apparatus of claim 1, wherein the lower display is further configured to allow a user to input a new scheduled event for display on the lower display on a particular date.

19. An apparatus for implementing a digital wall calendar comprising:
an upper display module for displaying an image and accepting user input to perform device configuration operations;
a lower display module for displaying a series of dates and accepting user input to select a date or modify a scheduled event; and
a logic and communication module for wireless communicating with a remote computer to synchronize scheduling information and for providing the image to the upper display module and the series of dates to the lower display module, wherein the image is selected from a photo album and wherein the image is associated with a particular date displayed on the lower display module, wherein the logic and communication module is configured to accept data from one or more streams, wherein the streams comprise scheduling information and one or more advertisements, wherein the logic and communication module is further configured to populate the lower display with the scheduling information.
